(19) United States
(12) Patent Application Publication
(10) Pub. No.: US 2016/0376771 A1
(43) Pub. Date: Dec. 29, 2016

(54) MULTI-SENSOR ULTRASONIC WEAR MEASUREMENT SYSTEM

(71) Applicant: CATERPILLAR INC., Peoria, IL (US)

(72) Inventors: Matthew Jacob Behmlander, Metamora, IL (US); Jeremy Roe Hammar, Metamora, IL (US); Jean Orseske Bridge, Metamora, IL (US)

(73) Assignee: CATERPILLAR INC., Peoria, IL (US)

(21) Appl. No.: 14/752,019

(22) Filed: Jun. 26, 2015

(51) Int. Cl. E02F 9/26; G01N 29/04; E02F 9/28

(52) U.S. Cl. CPC E02F 9/26; E02F 9/2808; E02F 9/2883; G01N 29/04; G01N 2291/023; G01N 2291/0289; G01N 2291/044

(57) ABSTRACT

A system for measuring wear performance of a ground engaging tool includes a first ultrasonic sensor that sends pulses in a direction substantially at a perpendicular to an unworn leading edge of the tool, and a second ultrasonic sensor that sends pulses in a direction at an angle offset with respect to the perpendicular to the unworn leading edge of the tool. The system also may include a wireless communication element sending signals from the ultrasonic sensors, and a controller receiving the signals from the communication element and determining wear performance of the ground engaging tool.

### TECHNICAL FIELD

The present disclosure relates generally to a wear measurement system and, more particularly, to a multi-sensor ultrasonic wear measurement system.

### BACKGROUND

Machines, for example motor graders, dozers, wheel loaders, track loaders, rippers, hydraulic excavators, and backhoes are commonly used for excavating, grading, and various material moving applications. These machines include an implement or ground engaging tool having a leading edge for cutting, digging, scraping, or otherwise configured to contact earth or other material. Often, the tool is abraded during use of the machine and engagement of its leading edge with earth or other material. Such abrasion causes wearing of the tool, resulting in changes in its character and often a decrease in its effectiveness. It is because of such wearing that ground engaging tools often have wear elements removably attached to the ground engaging tool and replaced on a periodic basis.

Generally, there is an acceptable limit of wear that may occur before the wear element should be replaced. Commonly, whether this acceptable limit has been reached is a determination made by a service technician who may be called out to the machine to take measurements of one or more parameters of the worn tool. The measurements taken are then compared to the acceptable limit for that particular tool, with selective replacement of the wear element being based on the comparison. This process of determining when to replace the wear element can be time and labor intensive and of questionable accuracy.

At times, a focus on wear of a tool may be primarily on a change in its length, for example the length of a wear element. In other words, wear beyond an acceptable limit may generally equate to a decrease in length beyond an acceptable amount as the leading edge recedes from wear. However, often the length of a ground engaging tool may decrease, but it may not decrease uniformly. The material engaged by the tool may not be of uniform hardness and abrasiveness. Also, the leading edge may not always engage the material uniformly or with uniform force. This may leave a leading edge that has a non-uniform wear pattern such as a non-uniform decrease in length across its width. It would be desirable and beneficial to be able both to ascertain wear patterns that affect a decrease in length of a tool, and to ascertain wear patterns other than a straightforward decrease in length of the tool due to recession of its leading edge.

A way to measure wear or damage of a cutting edge of a tool is described in U.S. Pat. No. 5,777,231 to Patel et al. that issued on Jul. 7, 1998 (“the '231 patent”). Specifically, the '231 patent discloses producing ultrasonic signal pulses in a piezoelectric coating contacting a tool insert having a cutting edge. The ultrasonic signal pulses in the '231 patent are directed through the tool insert substantially toward a surface region of the tool insert that is in close proximity to the cutting edge of the tool insert. The ultrasonic signal pulses in the '231 patent that are reflected back from the surface region of the tool insert, through the tool insert, and into the piezoelectric coating, are detected and compared to a reference signal pulse reflected from the surface region before the tool insert is initially contacted to a workpiece.

Although the wear sensor of the '231 patent may offer a way to measure wear of a cutting edge, it may be problematic. For example, excavating, grading, material moving, and ground engaging equipment may be subjected to extreme forces and may come in contact with heavy and highly abrasive material. The system disclosed in the '231 patent appears to be limited to cutting machines and processes operating on a fixed workpiece where forces and workpiece materials are readily predictable. Accordingly, employing a system such as that disclosed in the '231 patent in the harsh and less predictable environment to which the ground engaging tools of excavating, grading, and material moving equipment tend to be exposed may not be efficient. The complexity of the system of the '231 patent, with its piezoelectric layer deposited on the cutting tool or on a seat for the cutting tool, renders the application of such a system to a ground engaging tool infeasible. In addition, the system of the '231 patent may not be adaptable for giving a measure of uneven wear of a ground engaging tool.

The wear measurement system of the present disclosure addresses one or more of the needs set forth above and/or other problems of the prior art.

### SUMMARY

In one aspect, the present disclosure is directed to a system for measuring wear performance of a ground engaging tool of a machine including a first ultrasonic sensor within the ground engaging tool configured to send pulses in a direction substantially at a perpendicular to an unworn leading edge of the ground engaging tool. The system also includes a second ultrasonic sensor within the ground engaging tool and configured to send pulses in a direction at an angle offset with respect to the perpendicular to the unworn leading edge of the ground engaging tool. The system also includes a wireless communication element associated with the first and second ultrasonic sensors and configured to send signals from the ultrasonic sensors. The system also includes a controller configured to receive the signals from the communication element and determine wear performance of the ground engaging tool based on the received signals.

In another aspect, the present disclosure is directed to a ground engaging tool including a base, a wear element removably mounted to the base, and a cavity formed within the wear element. The ground engaging tool also includes a first ultrasonic sensor in the cavity and configured to send pulses in a direction substantially at a perpendicular to an unworn leading edge of the wear element. The ground engaging tool also includes a second ultrasonic sensor in the cavity and configured to send pulses in a direction at an angle offset with respect the perpendicular to the unworn leading edge of the wear element.

In another aspect, the present disclosure is directed to a machine including a ground engaging tool operatively associated with the machine, the ground engaging tool including a wear element and a cavity within the wear element. The machine also includes first and second ultrasonic sensors located within the cavity and configured to send ultrasonic pulses through the wear element, and configured to receive echoes of the pulses, the first ultrasonic sensor being oriented to send pulses in a first direction substantially perpendicular to a leading edge of the wear element in an unworn condition, and the second ultrasonic sensor being oriented to send pulses in a second direction at an angle offset from the first direction. The machine also includes a wireless communication element located in the cavity and configured to send signals based on data generated by the first and second ultrasonic sensors, and at least one battery configured to power the wireless communication element and the first and second ultrasonic sensors. The machine also includes a controller configured to receive the signals from the communication element, perform a triangulation calculation based the signals to generate wear performance data, compare the generated wear performance data with stored data representative of expected wear performance, and generate one of a record, a notification, and a warning in response to the comparison.

### BRIEF DESCRIPTION OF THE DRAWINGS

FIG. 1 is an illustration of an exemplary disclosed machine;

FIG. 2 is a perspective view of a wear element that may be used in conjunction with the machine of FIG. 1; and

FIG. 3 is a schematic illustration of multi-sensor ultrasonic wear measurement system according to a disclosed embodiment.

### DETAILED DESCRIPTION

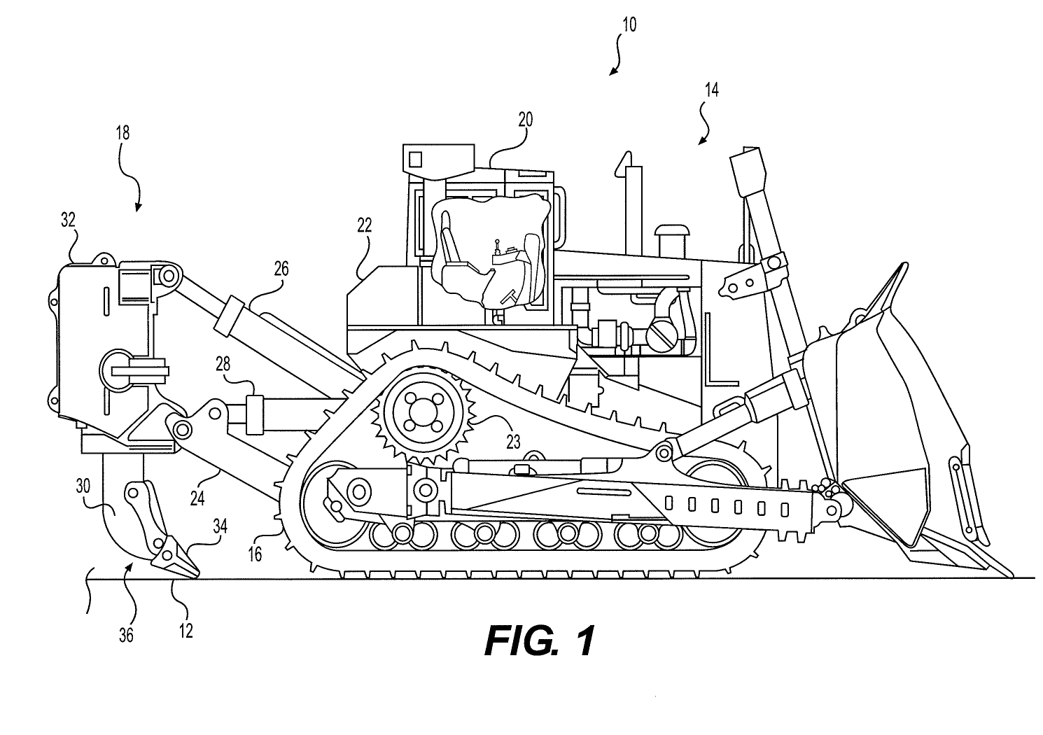

FIG. 1 illustrates an exemplary machine 10. Machine 10 may include any mobile machine that performs some type of operation associated with an industry, such as, for example, mining, construction, excavating, forestry, farming, etc. For example, machine 10 may be an earth moving machine such as a dozer, a ripper, a loader, a backhoe, an excavator, a motor grader, or any other earth or material moving machine. Machine 10 may traverse a work site to manipulate material beneath a work surface 12, e.g. transport, cultivate, dig, rip, scrape and/or perform other operations. Machine 10 may include a power source 14, such as, for example, a diesel engine, configured to produce mechanical power. Machine 10 may include a frame 22 with an on-board operator station 20 to house operator controls and electronic equipment or other equipment. Frame 22 may be supported for movement on a traction device 16, including, for example, a pair of tracks located on each side of machine 10 and driven by one or more sprockets, such as sprocket 23. Machine 10 also may include at least one ground engaging tool (GET) 18.

GET 18 may be configured for movement relative to frame 22, for example, for lifting, lowering, and tilting relative to frame 22 by suitable links and hydraulic rams such as link 24, hydraulic ram 26, and hydraulic ram 28. GET 18 may include a base 30 held in place by a mounting member 32. A wear element 34 may be mounted to a forward end 36 of base 30. For example, base 30 may be a ripper shank and wear element 34 may be a ripper tip, as illustrated in FIG. 1. Base 30 may be adjustable by raising and lowering within mounting member 32 to change the working length of base 30, and mounting member 32 with base 30 and mounted wear element 34 may be manipulated into engagement with the work surface 12 via link 24 and hydraulic rams 26, 28, for example. Machine 10 may move via traction device 16 and cause GET 18 to break up the ground or other material of work surface 12. Wear element 34 thus may tear or rip through material of work surface 12 which may be, for example, packed earth, friable rock, pavement to be removed, and various other materials which may advantageously be loosened by GET 18.

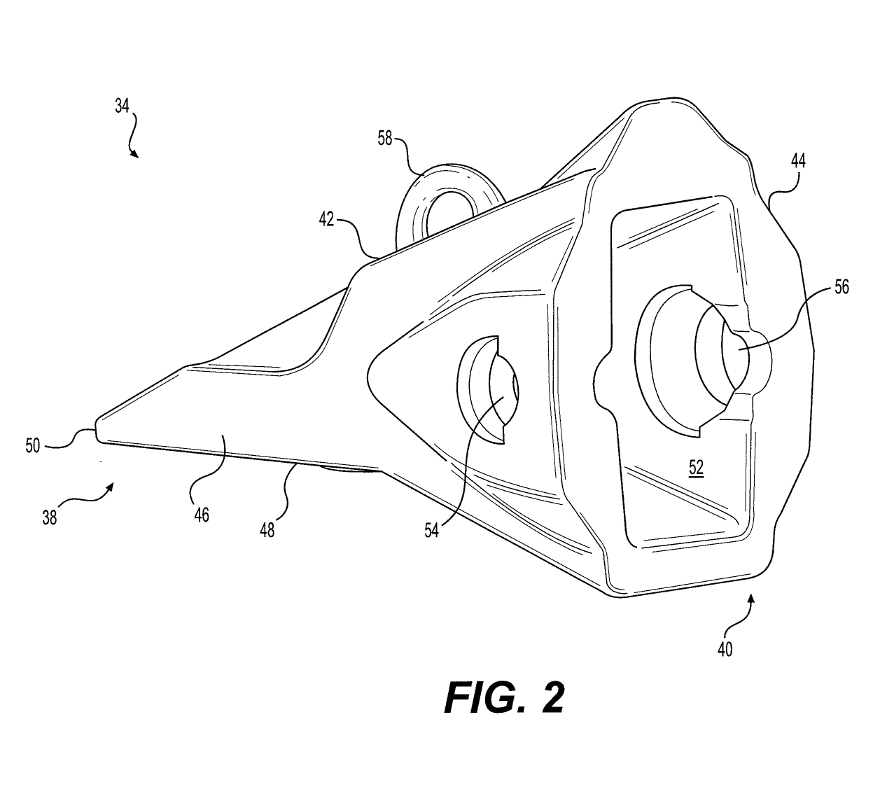

Wear element 34, mounted to forward end 36 of base 30, is illustrated separate from base 30 in FIG. 2, for example. Wear element 34 may include a front end 38 and a rear end 40. Extending between front end 38 and rear end 40, wear element 34 may include an upper surface 42, a side surface 44, a side surface 46, and a lower surface 48. Front end 38 of wear element 34 may form a leading edge 50. Wear element 34 may include a mounting pocket 52 extending inwardly from rear end 40. Mounting pocket 52 may have a shape configured to receive and mate with forward end 36 of base 30 (FIG. 1). Accordingly, wear element 34 may be removably mounted to base 30 by placing forward end 36 of base 30 in mounting pocket 52 of wear element 34 and fastening wear element 34 in place. Wear element 34 and base 30 may include various provisions, such as retaining elements (not shown) cooperating with aperture 54 and aperture 56, for fastening wear element 34 to base 30 and permitting removal of wear element 34 for replacement when worn beyond a predetermined threshold for wear. Wear element 34 also may include an eye 58 which may allow attaching a lifting apparatus to wear element 34 to facilitate maneuvering wear element 34 (which, in large machines, may weigh hundreds of pounds) during mounting or removal.

Leading edge 50 of wear element 34 (which also may be referred to as a cutting edge, a digging edge, a ground engaging edge, and other art recognized terms) may be configured to engage a material on work surface 12 (FIG. 1) and may experience wear with time and use. The length of time it may take for leading edge 50 to wear to a point that wear element 34 is not reasonably effective and should be replaced, may vary. This may depend on the type of machine 10 and the abrasive character of material engaged by leading edge 50. For large machines engaging highly abrasive material, wear element 34 may experience rapid wear, and wear element 34 may need to be replaced in a matter of days or even hours. After leading edge 50 has worn by a threshold amount that may be predetermined, wear element 34 should be replaced to help ensure productivity and/or efficiency of machine 10.

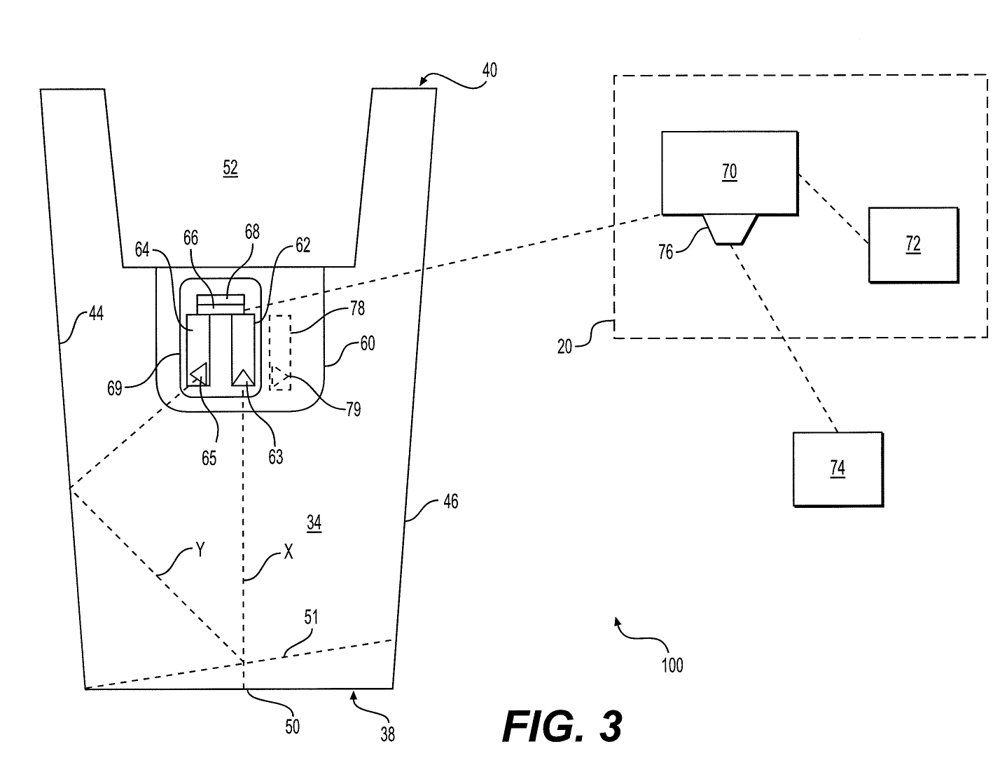

FIG. 3 is a diagrammatic illustration of a multi-sensor ultrasonic wear measurement system 100, and includes a stylized and diagrammatic plan view of the wear element 34 of FIG. 2. FIG. 3 is not to scale and the illustration of wear element 34 is not to scale. FIG. 3 illustrates leading edge 50, side surfaces 44 and 46, front end 38 and rear end 40. Also illustrated in FIG. 3 is mounting pocket 52 of wear element 34 which receives and mates with forward end 36 of base 30. A cavity 60 may be formed in pocket 52, for example as an extension of pocket 52, for receiving at least two ultrasonic sensors, such as first ultrasonic sensor 62 and second ultrasonic sensor 64 along with a wireless communication element 66 associated with first and second sensors 62 and 64. Cavity 60 may be formed during manufacture of wear element 34, and while illustrated and described as an extension of pocket 52, it is contemplated that cavity 60 could be formed in another location, for example through an upper surface of wear element 34 or through a bottom surface of wear element 34. A battery 68 also may be associated with ultrasonic sensors 62 and 64 and wireless communication element 66, and may be configured to power sensors 62 and 64, as well as wireless communication element 66. Battery 68 may store sufficient energy to power first and second ultrasonic sensors 62, 64 and wireless communication element 66 for an expected wear life of wear element 34. In addition to these components, wear measurement system 100 also may include a controller 70 mounted on-board machine 10, for example adjacent on-board operator station 20, and in communication with sensors 62 and 64 via communication element 66.

First and second sensors 62 and 64 may be any shape, for example generally cylindrical, and together with communication element 66 and battery 68, may be mounted together within wear element 34 of GET 18, and in a package 69 within cavity 60 of wear element 34. Once package 69 with sensors 62 and 64 and associated components have been mounted within cavity 60, cavity 60 may be closed off, for example permanently sealed or provided with a removable cover. Package 69 may be any general shape, such as generally cylindrical or ovoid in shape. While a single battery may be sufficient for powering communication element 66 and first and second sensors 62 and 64, it is contemplated that multiple batteries may be provided. Accordingly, the term “battery” for purposes of this disclosure includes both a single battery and plural batteries. In addition, it is contemplated that both sensors 62 and 64 could be provided either with a single communication element 66 and battery 68, or each sensor 62 or 64 could be provided with its own separate communication element 66 and battery 68. Ultrasonic sensors 62 and 64 each may have a transducer configured to generate ultrasonic signal pulses within wear element 34. For example, first ultrasonic sensor 62 may have a first transducer 63, and second ultrasonic sensor 64 may have a second transducer 65.

Signal pulses generated by ultrasonic sensors 62 and 64 via their respective transducers 63 and 65 produce echoes upon reaching a surface of wear element 34, such as leading edge 50. These echoes return to a sensor 62, 64 and may then be detected by the sensors 62, 64. A time interval between sending a signal pulse and receiving an echo may then be determined, and this determined time interval may allow a distance from sensor 62, 64 to the targeted surface portion of leading edge 50 to be calculated. It is contemplated that the sensor 62, 64 may be configured, for example via a suitable microprocessor, to make the calculations, or the calculations may be made by controller 70 after receiving data from sensors 62, 64 via communication element 66. The distance calculated is indicative of the length of wear element 34 from the sensor 62, 64 to leading edge 50, for example. Over time, as leading edge 50 wears and wear element 34 decreases in length, the time interval from sending a signal to receiving an echo by a sensor 62, 64 will decrease and yield a calculation representing a decreased distance to leading edge 50 and a decreased length of wear element 34. In this way, wear performance of GET 18 may be ascertained.

Referring still to FIG. 3, wear element 34 is schematically illustrated, with sensors 62 and 64 near one end of wear element 34. Sensors 62 and 64 may be arranged parallel to each other. Transducer 63 of sensor 62 may be arranged to send ultrasonic pulses in a first direction substantially at a perpendicular to leading edge 50 of wear element 34 when wear element 34 is in an unworn condition. Transducer 65 of sensor 64 may be arranged to send ultrasonic pulses in a second direction at an angle offset from the first direction. Accordingly, the path taken by ultrasonic pulses sent by sensor 62 will be different from the path taken by ultrasonic pulses sent by sensor 64. It will be understood that ultrasonic pulses emanate from transducers 63, 65 of respective sensors 62, 64 and are propagated through wear element 34 as ultrasonic waves, and that echoes of those ultrasonic pulses then return to sensors as reflected ultrasonic waves. First ultrasonic sensor 62 may receive echoes of pulses it has sent and second ultrasonic sensor 64 may receive echoes of pulses that it has sent.

Alternatively, sensors 62 and 64 may be arranged so that first ultrasonic sensor 62 is configured to receive echoes of pulses sent by second ultrasonic sensor 64, with second ultrasonic sensor 64 configured to receive echoes of pulses sent by first ultrasonic sensor 62. Where leading edge 50 of wear element 34 is in an unworn condition, or where leading edge 50 is in an evenly worn condition (e.g., worn parallel to the unworn leading edge 50), sensor 62, which sends pulses in a direction and along a path x substantially perpendicular to leading edge 50, will receive echoes in the form of reflected ultrasonic waves substantially along the same path x, and will permit, via straightforward calculation, an accurate determination of the distance from transducer 63 to leading edge 50. In the case of an evenly worn leading edge 50, the amount of recession of leading edge 50 then can be determined readily. Sensors 62 and 64 (as well as any additional sensors such as sensor 78 and its transducer 79 illustrated in dotted lines) each may be configured to recognize which sensor sent a signal that it may receive. That is to say, sensor 62 may recognize that a signal it has received was sent by sensor 64 (or sensor 78) and vice versa (along path y, for example). Thus when a worn leading edge 51, e.g., worn non-parallel to leading edge 50, is encountered by a signal from one sensor, the echo may be received and recognized by a different sensor.

Controller 70 may include a single microprocessor or multiple microprocessors that are configured to perform calculations necessary to accurately determine a wear pattern of leading edge 50 of wear element 34. Numerous commercially available microprocessors can be configured to perform the functions of controller 70. It should be appreciated that controller 70 could readily be embodied in a general machine microprocessor capable of controlling numerous machine functions. Controller 70 may include a memory, a secondary storage device, a processor, and any other components for running an application and/or processing and/or recording signals from sensors 62 and 64. Various other circuits may be associated with controller 70 such as power supply circuitry, signal conditioning circuitry, solenoid driver circuitry, and other types of circuitry.

One or more maps relating signals received via communication element 66 from sensors 62, 64 with wear patterns and various predetermined thresholds of wear for leading edge 50 of wear element 34 may be stored in the memory of controller 70. Each of these maps may include a collection of data in the form of tables, graphs, and/or equations. Controller 70 may be configured to select specific maps from available relationship maps stored in the memory of controller 70 to automatically determine and/or generate notifications regarding wear.

The notification generated by controller 70 may be shown on a display 72 associated with controller 70 and located within on-board operator station 18. The notification may provide a visual and/or audible alert regarding a current dimension of wear element 34, a wear pattern of leading edge 50, a remaining useful life of wear element 34, and/or a need to replace wear element 34. In this manner, the operator may be able to schedule maintenance of machine 10 and wear element 34 in advance of when leading edge 50 is worn so unevenly as to warrant replacement or when wear element 34 is effectively worn out.

Controller 70 may be able to communicate with an off-board entity 74 via a communication device 76. Communication device 76 may be configured to communicate messages wirelessly between controller 70 and off-board entity 74. The wireless communications may include satellite, cellular, infrared, and any other type of wireless communication. Off-board entity 74 may include, for example, service personnel, and the communications may include messages and/or data regarding wear information, such as wear pattern information relative to GET 18, wear element 34, and leading edge 50. Messages may include instructions for the service personnel, for example instructions relative to machine maintenance and/or replacement of worn wear elements.

### INDUSTRIAL APPLICABILITY

The disclosed multi-sensor ultrasonic wear measurement system 100 may be used with any machine having a ground engaging tool, and may enhance the collection of data regarding wear characteristics, such as wear patterns, of removable wear elements. The disclosed multi-sensor ultrasonic wear measurement system may be capable of determining a current length of a wear element, a non-uniform (e.g., non-parallel) wear pattern of the leading edge of a wear element, an amount of useful life remaining in the wear element and its leading edge, and/or a wear rate of the leading edge. The disclosed system also may be capable of displaying notifications regarding these parameters and/or communicating the notifications to an off-board entity. The notifications may be generated continuously or, alternatively, only after a comparison with one or more threshold values indicates the need to generate the notification, for example when the remaining useful life and/or current length is approaching or is less than a threshold life or length of the leading edge.

Since at least two sensors (62 and 64) are mounted in parallel, with at least one of the at least two sensors sending ultrasonic pulses in a direction substantially at a perpendicular to an unworn leading edge of a ground engaging tool (e.g., an associated wear element of a ground engaging tool) and the other sensor sending pulses in a direction at an angle offset with respect to the perpendicular to the unworn leading edge of the ground engaging tool, error readings for changes in length of leading edge 50 may be avoided. With use of the disclosed arrangement of multiple sensors and taking two readings, one at an angle relative to the other, a non-uniform wear pattern across leading edge 50 may be detected. The angle of offset for a transducer will be known and may vary considerably, for example ranging from a few degrees (e.g., 1-5 degrees) to thirty degrees or more.

The various parameters, including width and length of a GET, distance between an ultrasonic sensor and a leading edge of the GET, spacing between sensors, and the angle relative to a sensor that pulses emanate, may be known from manufacturing specifications. The initial difference in time from sending an ultrasonic pulse from an ultrasonic sensor until receiving an echo of the pulse can readily be determined for a new, unworn GET. This is true both for a transducer that sends signals in a direction at a perpendicular to a leading edge and for a transducer that sends signals in a direction at a known angle relative to the leading edge. Given all these known parameters, controller 70 may be configured to perform a triangulation calculation, based on data generated from signals from the first and second ultrasonic sensors, to determine a wear pattern of the leading edge of the ground engaging tool.

Controller 70 may be configured to then generate data indicative of a wear rate of the ground engaging tool. Controller 70 also may be configured to communicate data relevant to wear performance of the ground engaging tool to off-board station 74. Controller 70 may be configured to determine and generate data indicative of both the wear rate of the ground engaging tool and a wear pattern of the leading edge of the ground engaging tool by comparing data based on signals received from the communication element 66 with stored data representative of an unworn ground engaging tool. Controller 70 also may be configured to compare data generated from signals received from communication element 66 with threshold data for creating a notification and may be configured to create a notification signal, in the form of an audible and/or visual notification, for example, based on the comparison. The notification signal also may be a displayed image, for example on display 72, representing current wear performance of the ground engaging tool.

It will be understood that more than two ultrasonic sensors may be employed in GET 18 in some embodiments. For example, FIG. 3 illustrates, in dotted lines, a third ultrasonic sensor 78 with third transducer 79. Third transducer 79 may be oriented at an angle offset relative to both first transducer 63 of first ultrasonic sensor 62 and second transducer 65 of second ultrasonic sensor 64 so that third ultrasonic sensor 78 may be configured to send pulses in a direction at an angle with respect to the unworn leading edge 50 of GET 18 that is different from the directions of the pulses sent by first ultrasonic sensor 62 and second ultrasonic sensor 64. Accordingly, any number of sensors directing pulses at different angles may be employed. In particular, for a ground engaging tool that has a wide leading edge, it may be advantageous to employ several ultrasonic sensors in parallel along the width of the tool.

It will be apparent to those skilled in the art that various modifications and variations can be made to the multi-sensor ultrasonic measurement system of the present disclosure without departing from the scope of the disclosure. Other embodiments will be apparent to those skilled in the art from consideration of the specification and practice of the multi-sensor ultrasonic measurement system disclosed herein. It is intended that the specification and examples be considered as exemplary only, with a true scope of the disclosure being indicated by the following claims and their equivalent.

What is claimed is:

1. A system for measuring wear performance of a ground engaging tool of a machine, comprising:
a first ultrasonic sensor within the ground engaging tool configured to send pulses in a direction substantially at a perpendicular to an unworn leading edge of the ground engaging tool;
a second ultrasonic sensor within the ground engaging tool and configured to send pulses in a direction at an angle offset with respect the perpendicular to the unworn leading edge of the ground engaging tool;
a wireless communication element associated with the first and second ultrasonic sensors and configured to send signals from the ultrasonic sensors; and
a controller configured to receive the signals from the communication element and determine wear performance of the ground engaging tool based on the received signals.

2. The system of claim 1, further including a battery associated with the ultrasonic sensors and the wireless communication element.

3. The system of claim 2, wherein the battery, the ultrasonic sensors, and the wireless communication element are mounted together within the ground engaging tool.

4. The system of claim 3, wherein the battery, the ultrasonic sensors, and the wireless communication element are mounted together in a package, and the package is within a cavity formed in the ground engaging tool.

5. The system of claim 1, further including a display associated with the controller and configured to display an image representing current wear performance.

6. The system of claim 1, wherein the first and second ultrasonic sensors are arranged substantially parallel to each other, with the first ultrasonic sensor configured to receive echoes of pulses sent by the second ultrasonic sensor, and with the second ultrasonic sensor configured to receive echoes of pulses sent by the first ultrasonic sensor.

7. The system of claim 1, wherein the controller is located adjacent an on-board operator station of the machine, and is configured to generate data indicative of a wear pattern of the ground engaging tool.

8. The system of claim 7, wherein the controller is configured to perform a triangulation calculation, based on data generated from signals from the first and second ultrasonic sensors, to determine a wear pattern of the leading edge of the ground engaging tool.

9. The system of claim 7, wherein the controller is configured to generate data indicative of a wear rate of the ground engaging tool.

10. The system of claim 9, wherein the controller is configured to communicate data relevant to wear performance of the ground engaging tool to an off-board station.

11. The system of claim 9, wherein the controller is configured to determine the wear rate of the ground engaging tool and a wear pattern of the ground engaging tool by comparing data based on signals received from the communication element with stored data representative of an unworn ground engaging tool.

12. The system of claim 1, wherein the controller is configured to compare data generated from signals received from the communication element with threshold data for creating a notification, and is configured to create a notification signal based on the comparison.

13. The system of claim 12, wherein the notification signal is one of an audible notification and a visual notification.

14. The system of claim 12, wherein the notification signal is a displayed image representing current wear performance of the ground engaging tool.

15. The system of claim 1, including at least a third ultrasonic sensor within the ground engaging tool configured to send pulses in a direction at an angle with respect to the unworn leading edge of the ground engaging tool that is different from the directions of the pulses sent by the first and second ultrasonic sensors.

16. A ground engaging tool, comprising:
a base;
a wear element removably mounted to the base;
a cavity formed within the wear element;
a first ultrasonic sensor in the cavity and configured to send pulses in a direction substantially at a perpendicular to an unworn leading edge of the wear element; and
a second ultrasonic sensor in the cavity and configured to send pulses in a direction at an angle offset with respect the perpendicular to the unworn leading edge of the wear element.

17. The ground engaging tool of claim 16, further including a battery and a wireless communication element in the cavity, and wherein the battery stores sufficient energy to power the first and second ultrasonic sensors and the wireless communication element for an expected wear life of the wear element.

18. The ground engaging tool of claim 17, wherein the first and second ultrasonic sensors, the wireless communication element, and the battery are together in a package within the cavity.

19. The ground engaging tool of claim 16, wherein each of the first and second ultrasonic sensors includes an ultrasonic transducer configured to send an ultrasonic pulse through the wear element to the leading edge and receive an echo of an ultrasonic pulse from the leading edge.

20. A machine, comprising:
a ground engaging tool operatively associated with the machine, the ground engaging tool including a wear element;
a cavity within the wear element;
first and second ultrasonic sensors located within the cavity and configured to send ultrasonic pulses through the wear element, and configured to receive echoes of the pulses, the first ultrasonic sensor being oriented to send pulses in a first direction substantially perpendicular to the leading edge of the wear element in an unworn condition, and the second ultrasonic sensor being oriented to send pulses in a second direction at an angle offset from the first direction;
a wireless communication element located in the cavity and configured to send signals based on data generated by the first and second ultrasonic sensors, and at least one battery configured to power the wireless communication element and the first and second ultrasonic sensors; and
a controller configured to receive the signals from the communication element, perform a triangulation calculation based the signals to generate wear performance data, compare the generated wear performance data with stored data representative of expected wear performance, and generate one of a record, a notification, and a warning in response to the comparison.
